(19) United States
(12) Patent Application Publication
(10) Pub. No.: US 2008/0218221 A1
(43) Pub. Date: Sep. 11, 2008

(54) ANALOG SOURCE DRIVING APPARATUS

(75) Inventors: Chih-Jen Yen, Hsinchu City (TW); Chih-Yuan Hsieh, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 11/749,165

(22) Filed: May 16, 2007

(30) Foreign Application Priority Data
Mar. 9, 2007 (TW) 96108247

(51) Int. Cl. H02M 11/00

(52) U.S. Cl. 327/103

(57) ABSTRACT

An analog source driving apparatus including an operational amplifier, a first resistor, a second resistor, a variable gain unit and a source driver is provided. A constant gain amplifier is composed with the operational amplifier, the first resistor, and the second resistor, wherein the first resistor is coupled between the inverse input terminal of the operational amplifier and the ground, and the second resistor is coupled between the inverse input terminal and the output terminal of the operational amplifier. The variable gain unit is coupled to an analog signal and the non-inverse input terminal of the operational amplifier for adjusting the analog signal to avoid affecting the zero point position and pole position of the system. Accordingly, the analog source driving apparatus can provide a stable driving output.

### CROSS-REFERENCE TO RELATED APPLICATION

This application claims the priority benefit of Taiwan application serial no. 96108247, filed Mar. 9, 2007. All disclosure of the Taiwan application is incorporated herein by reference.

### BACKGROUND OF THE INVENTION

1. Field of the Invention

The present invention generally relates to an analog source driving apparatus, and more particularly, to an analog source driving apparatus that can adjust the gain and provide a stable output.

2. Description of Related Art

The outputs of video decoders are generally categorized into digital signals and analog signals. However, signals from video decoder to display panel are mostly restricted to digital signals because analog signals require more complicated processing technique. If analog signal is adopted, the analog signal received by a analog source driving apparatus is usually very small in order to minimize the power consumption of signal transmission and to avoid electromagnetic interference (EMI) caused by large electromagnetic wave emission. Accordingly, the analog source driving apparatus has to amplify the analog signal to restore regular driving amplitude.

FIG. 1 is a block circuit diagram of a conventional analog source driving apparatus. Referring to FIG. 1, the conventional analog source driving apparatus 101 includes a variable gain amplifying circuit 103 and a source driver 107. The variable gain amplifying circuit 103 includes an operational amplifier 111, a variable resistor R1, and a variable resistor R2, wherein the feedback-controlled gain of the variable gain amplifying circuit 103 can be changed by adjusting the variable resistors R1 or R2, so that the received analog signal Vs can be amplified.

To show the disadvantage of the conventional analog source driving apparatus 101 below, it is assumed that the equivalent input capacitance at the reverse input terminal of the operational amplifier 111 is Cin, and the equivalent output capacitance at the output terminal of the operational amplifier 111 is Cout. The equivalent input resistance obtained at the inverse input terminal of the operational amplifier 111 is Rin, and the equivalent input resistance Rin is the resistance of the variable resistors R1 and R2 in parallel connection, wherein Rin=[R1×R2/(R1+R2)]. Next, the equivalent output resistance obtained at the output terminal of the operational amplifier 111 is Rout, and the equivalent output resistance Rout is the resistance of the variable resistors R1 and R2 connected in series, wherein Rout=R1+R2. However, when the variable resistors R1 or R2 are adjusted, the originally feedback-controlled equivalent input resistance Rin and equivalent output resistance Rout are affected so that the products of the equivalent resistances and the equivalent capacitances (Rin×Cin and Rout×Cout) are changed accordingly, and further, the positions of the zero point and pole point of the feedback control are also affected. According to this method of adjusting the variable resistor R1 or variable resistor R2, the position shift of the zero point and pole point will affect the stability of the entire analog source driving apparatus 101 and further the grey scale and color of the display panel 109, and therefore the display panel 109 cannot present images with exquisite shading.

### SUMMARY OF THE INVENTION

Accordingly, the present invention is directed to an analog source driving apparatus having broad gain adjust range, wherein the analog source driving apparatus is capable of adjusting the gain of an analog signal without affecting the original zero point position and pole point position.

The present invention provides an analog source driving apparatus including an operational amplifier, a first resistor, a second resistor, a variable gain unit, and a source driver. The operational amplifier comprises an output terminal, an inverse input terminal and a non-inverse input terminal, and is used for receiving a first voltage and outputting a second voltage. The first resistor comprises a first terminal and a second terminal, wherein the first terminal is coupled to the inverse input terminal of the operational amplifier, and the second terminal is grounded. The second resistor has a first terminal and a second terminal, wherein the first terminal is coupled to the inverse input terminal of the operational amplifier and the first terminal of the first resistor, and the second terminal of the second resistor is coupled to the output terminal of the operational amplifier. The variable gain unit is coupled to the non-inverse input terminal of the operational amplifier. The variable gain unit receives and adjusts an analog signal and generates the first voltage according to the analog signal. The source driver is coupled to the output terminal of the operational amplifier and receives the second voltage for driving a display panel.

According to an embodiment of the present invention, the variable gain unit in the analog source driving apparatus may include a first variable resistor and a second variable resistor. The first variable resistor receives the analog signal. The second variable resistor is coupled between the first variable resistor and the ground. The first voltage is obtained at the coupling point of the first variable resistor and the second variable resistor.

According to an embodiment of the present invention, the variable gain unit in the analog source driving apparatus may include a third variable resistor and a third resistor. The third variable resistor receives the analog signal. The third resistor is coupled between the third variable resistor and the ground. The first voltage is obtained at the coupling point of the third variable resistor and the third resistor.

According to an embodiment of the present invention, the variable gain unit in the analog source driving apparatus may include a fourth resistor and a fourth variable resistor. The fourth resistor receives the analog signal. The fourth variable resistor is coupled between the fourth resistor and the ground. The first voltage is obtained at the coupling point of the fourth resistor and the fourth variable resistor.

According to an embodiment of the present invention, the variable gain unit in the analog source driving apparatus may include a current adjust circuit and a fifth variable resistor. The current adjust circuit has a first terminal and a second terminal, and the first terminal of the current adjust circuit is coupled to the analog signal. The fifth variable resistor is coupled between the second terminal of the current adjust circuit and the ground, wherein the current adjust circuit outputs an adjusted current according to the analog signal, and the first voltage is obtained at the coupling point of the current adjust circuit and the first variable resistor.

According to an embodiment of the present invention, the variable gain unit in the analog source driving apparatus may include a first variable current adjust circuit and a fifth resistor. The first variable current adjust circuit comprises a first terminal and a second terminal, and the first terminal of the first variable current adjust circuit is coupled to the analog signal. The fifth resistor is coupled between the second terminal of the first variable current adjust circuit and the ground, wherein the first variable current adjust circuit outputs a first variable current according to the analog signal and adjusts the first variable current, and the first voltage is obtained at the coupling point of the first variable current adjust circuit and the fifth resistor.

According to an embodiment of the present invention, the variable gain unit in the analog source driving apparatus may include a second variable current adjust circuit and a sixth variable resistor. The second variable current adjust circuit comprises a first terminal and a second terminal, and the first terminal of the second variable current adjust circuit is coupled to the analog signal. The sixth variable resistor is coupled between the second terminal of the second variable current adjust circuit and the ground, wherein the second variable current adjust circuit outputs a second variable current according to the analog signal and adjusts the second variable current, and the first voltage is obtained at the coupling point of the second variable current adjust circuit and the sixth variable resistor.

The present invention further provides an analog source driving apparatus including a variable gain amplifying circuit and a source driver. The variable gain amplifying circuit includes a variable gain unit and a constant gain amplifying circuit. The variable gain unit receives and adjusts an analog signal and generates a first voltage according to the analog signal, wherein the variable gain unit is composed of passive elements. The constant gain amplifying circuit is coupled to the variable gain unit and receives and amplifies the first voltage in order to output a second voltage. The source driver is coupled to the output of the constant gain amplifying circuit and receives the second voltage for driving a display panel.

According to an embodiment of the present invention, the variable gain unit in the analog source driving apparatus may include a first variable resistor and a second variable resistor. The first variable resistor receives the analog signal. The second variable resistor is coupled between the first variable resistor and the ground. The first voltage is obtained at the coupling point of the first variable resistor and the second variable resistor.

According to an embodiment of the present invention, the variable gain unit in the analog source driving apparatus may include a third variable resistor and a first resistor. The third variable resistor receives the analog signal. The first resistor is coupled between the third variable resistor and the ground. The first voltage is obtained at the coupling point of the third variable resistor and the first resistor.

According to an embodiment of the present invention, the variable gain unit in the analog source driving apparatus may include a second resistor and a fourth variable resistor. The second resistor receives the analog signal. The fourth variable resistor is coupled between the second resistor and the ground. The first voltage is obtained at the coupling point of the second resistor and the fourth variable resistor.

In an analog source driving apparatus provided by the present invention, a variable gain unit is adopted for receiving and modulating an analog signal. The variable gain unit adjusts the analog signal in an open-loop pattern, therefore the variable gain unit does not affect the zero point position and pole point position of the subsequently coupled feedback circuit, wherein the feedback circuit may be an amplifying circuit formed by an operational amplifier and resistors or a constant gain amplifying circuit. Since the equivalent input resistance and equivalent output resistance of the feedback circuit are not changed, the original zero point position and pole point position of the feedback circuit are also not changed. Accordingly, the zero point position and pole point position of the feedback circuit can be maintained stable when the variable gain unit is adopted for modulating the gain and amplifying the analog signal. According to embodiments of the present invention, the analog source driving apparatus comprises broad gain adjustment range and can maintain the original stability of an amplified analog signal. Thus, the analog source driving apparatus can provide a stable driving output.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block circuit diagram of a conventional analog source driving apparatus.

FIG. 2 is a block circuit diagram of an analog source driving apparatus according to an embodiment of the present invention.

FIGS. 3˜8 are circuit diagrams of variable gain units according to embodiments of the present invention.

FIGS. 9˜11 are circuit diagrams of variable resistors according to embodiments of the present invention.

FIGS. 12˜15 are diagrams of variable current adjust circuit according to embodiments of the present invention.

FIG. 16 is a block circuit diagram of an analog source driving apparatus according to another embodiment of the present invention.

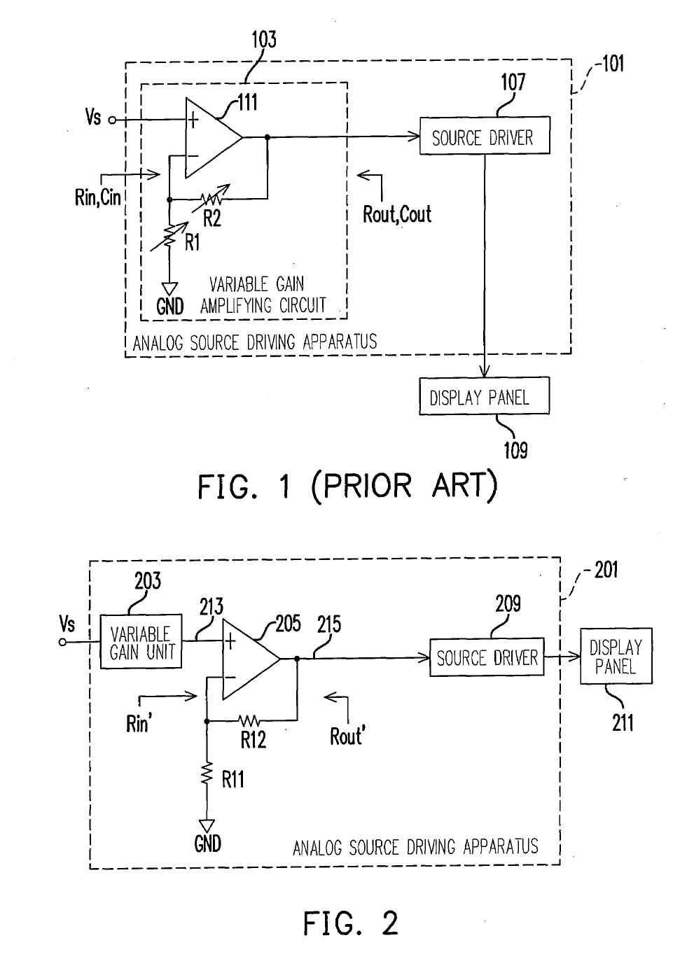

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

FIG. 2 is a block circuit diagram of an analog source driving apparatus according to an embodiment of the present invention. Referring to FIG. 2, the analog source driving apparatus 201 includes a variable gain unit 203, an operational amplifier 205, a resistor R11, a resistor R12 and a source driver 209. The various components and couplings thereof of the analog source driving apparatus 201 will be described herein. The operational amplifier 205 comprises an output terminal, an inverse input terminal and a non-inverse input terminal. The variable gain unit 203 receives an analog signal Vs, and the output of the variable gain unit 203 is coupled to the non-inverse input terminal of the operational amplifier 205. The resistor R11 is coupled between the inverse input terminal of the operational amplifier 205 and the ground. One terminal of the resistor R12 is coupled to the inverse input terminal of the operational amplifier 205, and the other terminal of the resistor R12 is coupled to the output terminal of the operational amplifier 205. The source driver 209 is coupled to the output terminal of the operational amplifier 205.

Next, the working principle of the analog source driving apparatus 201 will be described. First, the operational amplifier 205, the resistor R11 and the resistor R12 are coupled and form a closed-loop amplifying circuit, wherein the resistor R11 and the resistor R12 have constant resistances therefore the operational amplifier 205 provides a value with constant gain 1+(R12/R11). The variable gain unit 203 adjusts the gain of the analog source driving apparatus 201, and because the variable gain unit 203 receives the analog signal Vs and outputs the adjusted analog signal Vs in a single direction. There is no closed-loop path formed during the gain adjust procedure of the analog signal Vs, and this variable gain unit 203 does not form any closed-loop path with any other unit circuit. After the variable gain unit 203 receives an analog signal Vs, the variable gain unit 203 adjusts the gain of the analog signal Vs and generates a first voltage 213 accordingly. Next, the non-inverse input terminal of the operational amplifier 205 receives the first voltage 213, and the operational amplifier 205 amplifies the first voltage 213 and outputs a second voltage 215. Finally, the source driver 209 receives the second voltage 215 for driving a display panel 211.

In the present embodiment, the source driver 209 operates same as that in a conventional analog source driving apparatus therefore description thereof is not repeated.

The foregoing path for adjusting the gain of the analog signal Vs starts from the reception of the variable gain unit 203 until the non-inverse input terminal of the operational amplifier 205. Because the path for adjusting the gain of the analog signal Vs is an open-loop path and both the resistor R11 and the resistor R12 are constant resistances, the equivalent input resistance Rin′ obtained from the inverse input terminal of the operational amplifier 205 is a constant value, i.e. Rin′=[R11×R12/(R11+R12)], and the equivalent output resistance Rout′ obtained from the output terminal of the operational amplifier 205 is also a constant value, i.e. Rout′=R11+R12. The equivalent input resistance Rin′ and the equivalent output resistance Rout′ of the closed-loop feedback control of the operational amplifier 205 are all constant both before and after adjusting the variable gain unit 203. Thus, the zero point position and pole point position of the feedback control system are also not changed, so that the analog source driving apparatus 201 can maintain its stability. The feedback interactions of elements coupled subsequently will not be affected by adjusting the analog signal Vs with the variable gain unit 203.

Referring to FIG. 2 again, in another embodiment of the present invention, the resistor R11 may be infinite and the resistor R12 may be 0, namely, R11=∞ and R12=0. Thus, the operational amplifier 205, the resistor R11, and the resistor R12 are coupled to form a unity-gain amplifying circuit. Operational amplifier 205 may be used as a buffer for receiving the analog signal Vs or for the input of the source driver 209.

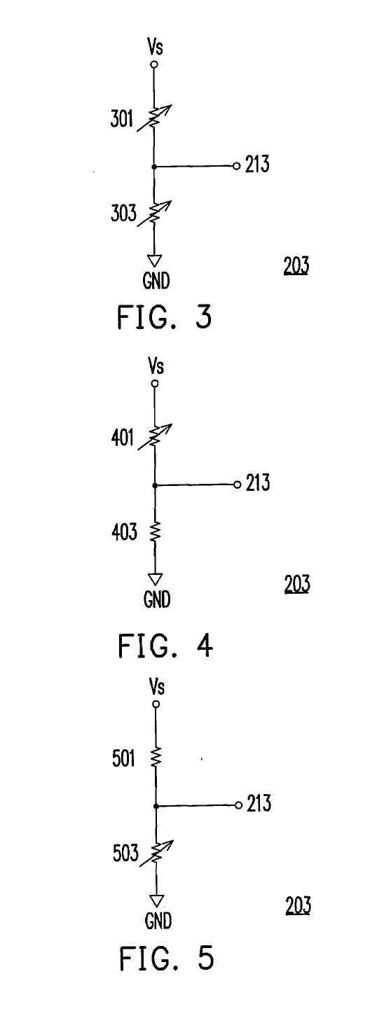

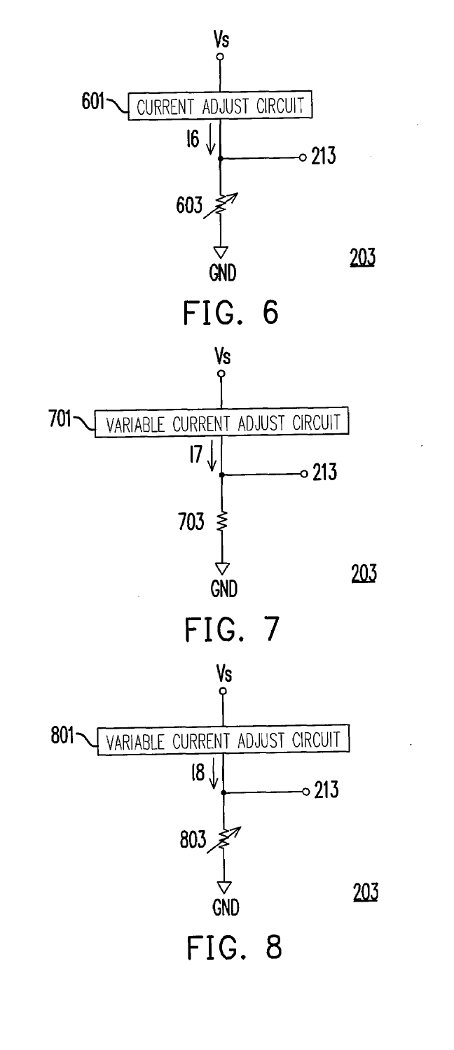

In addition, the implementation of the variable gain unit 203 is further illustrated in FIGS. 3˜8. FIGS. 3˜8 are circuit diagrams of variable gain units 203 according to embodiments of the present invention; however, the present invention is not limited to the examples illustrated herein. First, referring to FIG. 3, the variable gain unit 203 has a variable resistor 301 and a variable resistor 303, wherein the variable resistor 303 is coupled between the variable resistor 301 and the ground GND. When the variable resistor 301 receives an analog signal Vs, a first voltage 213 is output at the coupling point between the variable resistors 301 and 303. Thus, the gain of the variable gain unit 203 can be adjusted by adjusting the variable resistor 301 or the variable resistor 303.

Referring to FIG. 4, the variable gain unit 203 has a variable resistor 401 and a resistor 403. Next, referring to FIG. 5, the variable gain unit 203 uses a resistor 501 and a variable resistor 503. In foregoing FIGS. 4 and 5, the first voltage 213 is always output from the coupling point of two resistors, therefore during the operation, resistors are used for voltage division, and accordingly the gain thereof is always below 1. However, the present invention is not limited to as such, any other coupling with a gain greater than or equal to 1 is also construed to be within the scope of the present invention.

Referring to FIG. 6, the variable gain unit 203 has a current adjust circuit 601 and a variable resistor 603, wherein the variable resistor 603 is coupled between the current adjust circuit 601 and the ground GND. Here, it is assumed that the current adjust circuit 601 receives an analog signal Vs and the adjusted analog signal Vs is transmitted as an adjusted current 16. In the present embodiment, the current adjust circuit 601 outputs an adjusted current 16 according to the analog signal Vs, wherein the adjusted current I6 is related to the analog signal Vs but not related to the voltage over the input and output terminals of the current adjust circuit 601. In addition, the analog signal Vs may enter the current adjust circuit 601 as a current signal. The adjusted current I6 is expressed as I6=f1(Vs), wherein f1 ( ) is a function. Since the input impedance at the non-inverse input terminal of the operational amplifier 205 in FIG. 2 is infinite and no current is allowed to enter the non-inverse input terminal of the operational amplifier 205, the adjusted current I6 totally passes through the variable resistor 603 and accordingly forms a voltage drop over two terminals of the variable resistor 603. The first voltage 213 may be obtained at the coupling point between the variable resistor 603 and the current adjust circuit 601. In addition, the first voltage 213 can be changed by adjusting the resistance of the variable resistor 603.

Referring to FIG. 7, the variable gain unit 203 has a variable current adjust circuit 701 and a resistor 703, wherein the resistor 703 is coupled between the variable current adjust circuit 701 and the ground GND. Here, it is assumed that the variable current adjust circuit 701 receives an analog signal Vs and the adjusted analog signal Vs is transmitted as a variable current I7. In the present embodiment, besides outputting a variable current I7 according to the analog signal Vs, the variable current adjust circuit 701 also adjusts the variable current I7, wherein the variable current I7 is related to the analog signal Vs and a reference voltage.

According to another embodiment of the present invention, the variable current adjust circuit 701 includes the current adjust circuit 601 illustrated in FIG. 6 and a plurality of metal oxide semiconductor (MOS) transistors, wherein the MOS transistors are coupled together to form a current mirror circuit which can multiply a current. The variable current I7 is expressed as I7=f2(Vs, W/L), wherein f2( ) is a function, W and L are respectively the channel width and channel length of the MOS transistors, and the variable current I7 is related to the analog signal Vs and W/L. Since no current is allowed to enter the non-inverse input terminal of the operational amplifier 205, the adjusted variable current I7 passes through the resistor 703 totally and accordingly a voltage drop is formed over two terminals of the resistor 703. Accordingly, a first voltage 213 can be obtained at the coupling point between the resistor 703 and the variable current adjust circuit 701.

Referring to FIG. 8, the variable gain unit 203 comprises a variable current adjust circuit 801 and a variable resistor 803, wherein the variable resistor 803 is coupled between the variable current adjust circuit 801 and the ground GND. It is assumed here that the variable current adjust circuit 801 receives an analog signal Vs and the adjusted analog signal Vs is transmitted as a variable current I8. Besides outputting a variable current I8 according to the analog signal Vs, the variable current adjust circuit 801 also adjusts the variable current I8. In the present embodiment, the working principles of the variable current adjust circuit 801 and the variable resistor 803 can be deduced from foregoing descriptions described with reference to FIGS. 6 and 7, and therefore will not be repeated.

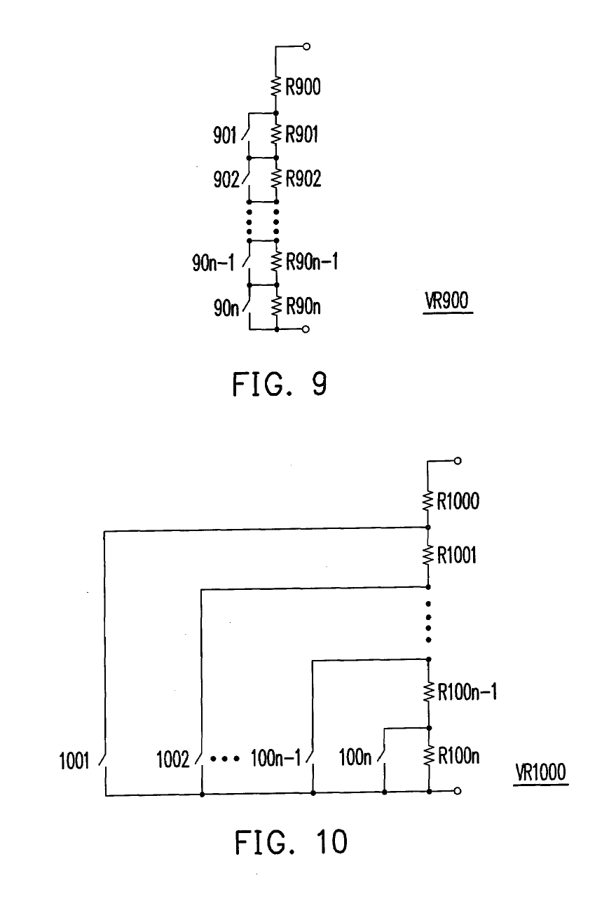

Referring to FIGS. 9˜11, more implementations of any one of the variable resistors 301, 303, 401, 503, 603, and 803 are illustrated. FIGS. 9˜11 illustrate circuit diagrams of variable resistors according to the embodiments of the present invention. First, referring to FIG. 9, the coupling of the variable resistor VR900 is illustrated, and the two terminals of each resistor among the resistors R901˜R90n except the resistor R900 are coupled to the two terminals of a corresponding switch in parallel, wherein the resistor R901 is connected to the switch 901 in parallel, the resistor R902 is connected to the switch 902 in parallel, and so on, until the resistor R90n-1 is connected to the switch 90n in parallel. Next, the resistors are all connected in series, wherein the resistor R900 is connected to the resistor R901 in series, the resistor R901 is connected to the resistor R902 in series, and so on, until the resistor R90n-1 is connected to the resistor R90n in series. Finally, a variable resistor VR900 is formed. The resistance of the variable resistor VR900 can be adjusted by controlling the on and off of the switches 901˜90n.

Referring to FIG. 10, the variable resistor VR1000 includes resistors R1000˜R100n and switches 1001˜100n. Each of the resistors R1000˜R100n comprises a first terminal and a second terminal, wherein the second terminal of the resistor R1000 is coupled to the first terminal of the resistor R1001, the second terminal of the resistor R1001 is coupled to the first terminal of the resistor R1002, and so on, until the second terminal of the resistor R100n-1 is coupled to the first terminal of the resistor R100n. Each of the switches 1001˜100n comprises a first terminal and a second terminal, wherein the second terminals of the switches are all coupled to the second terminal of the resistor R100n, the first terminal of the switch 1001 is coupled between the resistors R1000 and R1001, the first terminal of the switch 1002 is coupled between the resistors R1001 and R1002, and so on, until the first terminal of the switch 100n is coupled between the resistors R100n-l and R100n. The resistance of the variable resistor VR1000 can be adjusted by controlling the on and off states of the switches 1001˜100n.

Next, referring to FIG. 11, the variable resistor VR1100 includes resistors R1101˜R110n and switches 1101˜110n, wherein each resistor or switch comprises a first terminal and a second terminal. The couplings between various components of the variable resistor VR1100 will be described herein. The second terminal of the resistor R1101 is coupled to the first terminal of the switch 1101, the second terminal of the resistor R1102 is coupled to the first terminal of the switch 1102, and so on, until the second terminal of the resistor R110n is coupled to the first terminal of the switch 110n. Next, the first terminals of the resistors R1101˜R110n are all coupled together, and the second terminals of the switches 1101˜110n are all coupled together. The resistance of the variable resistor VR1100 can be adjusted by controlling the on and off of the switches 1101˜110n.

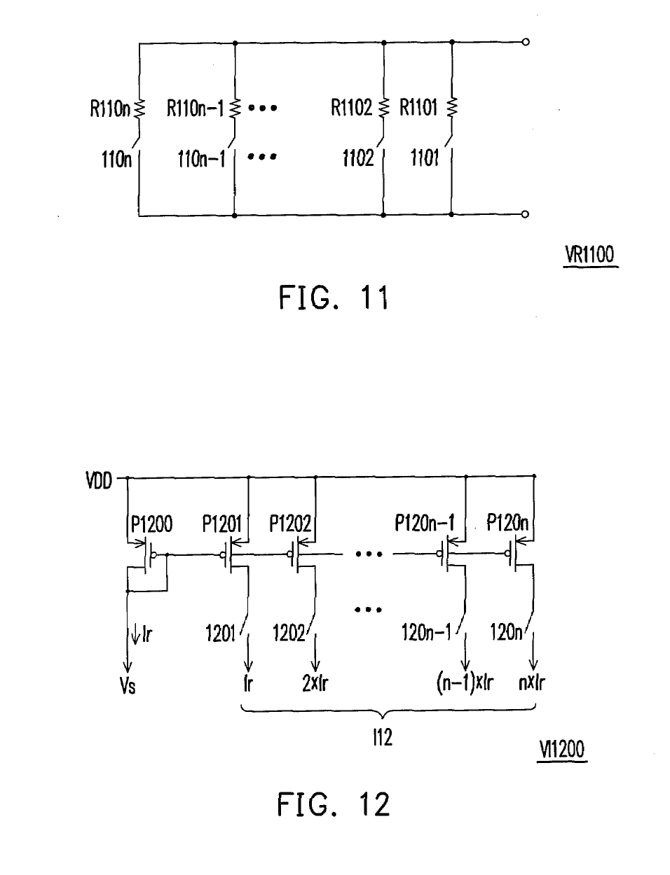

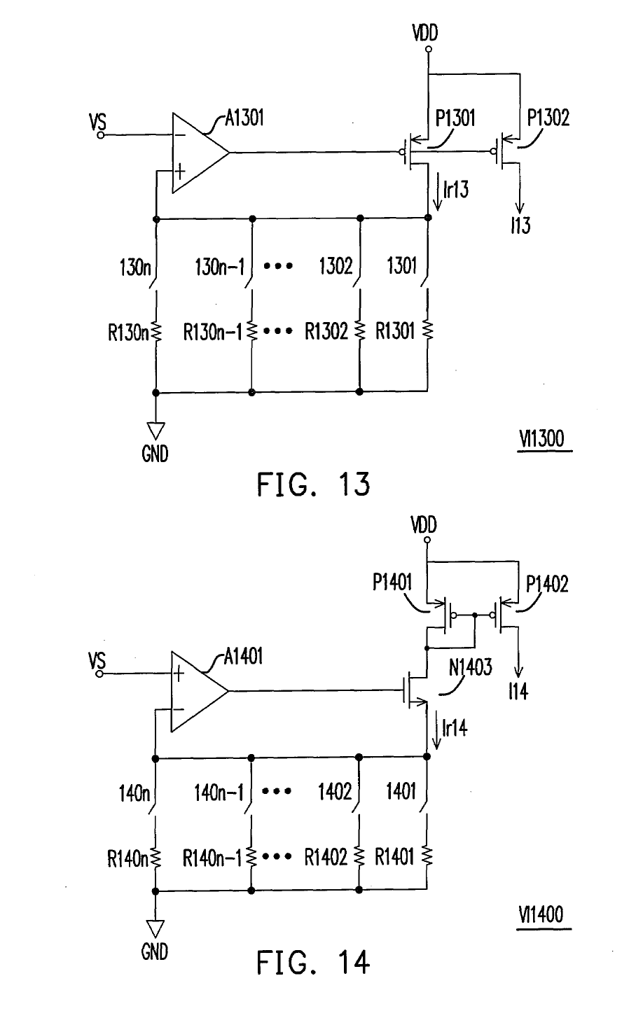

Even though various embodiments of a variable resistor have been illustrated in FIGS. 9˜11, the present invention is not limited to foregoing implementations. According to other embodiments of the present invention, the variable current adjust circuits 701 and 801 in FIGS. 7 and 8 may be further implemented as illustrated in FIGS. 12˜15. FIGS. 12˜15 illustrate diagrams of variable current adjust circuits according to the embodiments of the present invention.

Referring to FIG. 12, the variable current adjust circuit VI1200 includes PMOS transistors P1200˜P120n and switches 1201˜120n, wherein each of the PMOS transistors comprises a source, a drain and a gate. The couplings between various components of the variable current adjust circuit VI1200 will be described herein. The sources of the PMOS transistors P1200˜P120n are all coupled to a supply voltage VDD, the gates of the PMOS transistors P1200˜P120n are all coupled together, the gate of the PMOS transistor P1200 is coupled to the drain thereof, and the drain of the PMOS transistor P1200 receives an analog signal Vs. The output of the variable current adjust circuit VI1200 is an adjustable variable current I12. The coupling pattern of the variable current adjust circuit VI1200 forms a current mirror circuit. When the analog signal Vs is inputted as a current signal, as the input current Ir illustrated in FIG. 12, a variable current I12 in multiple of the analog signal Vs is outputted by controlling the on/off states of the switches 1201˜120n. When the PMOS transistor P1200 and the PMOS transistors P1201˜P120n have the same channel length, the current mirror circuit amplifies the input current Ir with a multiple of a particular channel width to generate a variable current I12. The variable current I12 is outputted based on the on/off states of the switches 1201˜120n. The variable current I12 is a particular multiple, which is from 1 to n and n is a positive integer, of the input current Ir. For example, when the switch 1202 is turned on, the variable current I12 output by the variable current adjust circuit VI1200 is two times of the input current Ir, i.e. I12=2×Ir.

Referring to FIG. 13, the variable current adjust circuit VI1300 includes an amplifier A1301, PMOS transistors P1301˜P1302, switches 1301˜130n, and resistors R1301˜R130n. The couplings between various components of the variable current adjust circuit VI1300 will be described herein. The amplifier A1301 has an inverse input terminal, a non-inverse input terminal, and an output terminal. The inverse input terminal of the amplifier A1301 is coupled to the analog signal Vs, and the output terminal of the amplifier A1301 is coupled to the gates of the PMOS transistors P1301 and P1302. The sources of the PMOS transistors P1301 and P1302 are both coupled to a supply voltage VDD. Each of the switches 1301˜130n or resistors R1301˜R130n comprises a first terminal and a second terminal. The first terminals of the switches 1301˜130n are all coupled to the non-inverse input terminal of the amplifier A1301 and the drain of the PMOS transistor P1301. The second terminal of the switch 1301 is coupled to the first terminal of the resistor R1301, the second terminal of the switch 1302 is coupled to the first terminal of the resistor R1302, and so on, until the second terminal of the switch 130n is coupled to the first terminal of the resistor R130n. Then the second terminals of the switches 1301˜130n are all grounded.

As described above, the voltage level of the inverse input terminal of the amplifier A1301 is the analog signal Vs, and the voltage level of the non-inverse input terminal of the amplifier A1301 is also the analog signal Vs due to virtual short circuit characteristic thereof. The quantity of the drain current Ir13 of the PMOS transistor P1301 is determined by the on/off states of the controlling switch. For example, when the switch 1301 is turned on, Ir13=Vs/R1301; when the switch 1302 is turned on, Ir13=Vs/R1302; and when the switch 130n is turned on, the variable current Ir13=Vs/R130n.

Accordingly, if the switches 1301˜130n are turned on in sequence, the variable current I13 will be changed gradually. Or, the variable current I13 may also be fixed to certain value by turning on only a particular switch. In addition, if the PMOS transistors P1301 and P1302 have the same channel width and channel length and the voltage Vgs1 from the gate to the source of the PMOS transistor P1301 is the same as the voltage Vgs2 from the gate to the source of the PMOS transistor P1302, i.e. Vgs1=Vgs2, the drain current Ir13 of the PMOS transistor P1301 is equal to the drain current I13 of the PMOS transistor P1302, i.e. Ir13=I13, wherein the drain current I13 is the output of the variable current adjust circuit VI1300, and the drain current Ir13 of the PMOS transistor P1301 is also the outputted variable current I13, and the calculation of the variable current I13 can be obtained from foregoing description.

Referring to FIG. 14, the variable current adjust circuit VI1400 includes an amplifier A1401, PMOS transistors P1401˜PI402, an NMOS transistor N1403, switches 1401˜140n, and resistors R1401˜R140n. The couplings of various components of the variable current adjust circuit VI1400 will be described herein. The amplifier A1401 has an inverse input terminal, a non-inverse input terminal, and an output terminal, wherein the non-inverse input terminal of the amplifier A1401 is coupled to the analog signal Vs and the output terminal of the amplifier A1401 is coupled to the gate of the NMOS transistor N1403. The sources of the PMOS transistors P1401 and P1402 are both coupled to a supply voltage VDD, and the gates of the PMOS transistors P1401 and P1402 are both coupled to the drain of the NMOS transistor N1403. Each of the switches 1401˜140n and the resistors R1401˜R140n has a first terminal and a second terminal. The first terminals of the switches 1401˜140n are all coupled to the inverse input terminal of the amplifier A1401 and the source of the NMOS transistor N1403. The second terminal of the switch 1401 is coupled to the first terminal of the resistor R1401, the second terminal of the switch 1402 is coupled to the first terminal of the resistor R1402, and so on, until the second terminal of the switch 140n is coupled to the first terminal of the resistor R140n. The second terminals of the resistors R1401 R140n are all grounded.

As described above, the working principle of the variable current adjust circuit VI1400 is similar to that of the variable current adjust circuit VI1300 as illustrated in FIG. 13, wherein the variable current I14 is equal to the drain current (or source current) Ir14 of the NMOS transistor N1403, and the turn-on quantity and the calculation of the drain current Ir14 are the same as those of the drain current Ir13 in FIG. 13, and therefore will not be described herein.

Referring to FIG. 15, the variable current adjust circuit VI1500 includes resistors R1500˜R150n+1, switches 1501˜150n, an amplifiers A1501, PMOS transistors P1501˜P1502, and a resistor Rb. The couplings between various components of the variable current adjust circuit VI1500 will be described herein. Each of the resistors R1500˜R150n+1 and Rb and switches 1501˜150n comprises a first terminal and a second terminal. The amplifier A1501 has an inverse input terminal, a non-inverse input terminal, and an output terminal. The first terminal of the resistor R1500 is coupled to the analog signal Vs. The second terminal of the resistor R1500 is coupled to the first terminal of the resistor R1501 and the first terminal of the switch 1501, the second terminal of the resistor R1501 is coupled to the first terminal of the resistor R1502, the second terminal of the switch 1501, and the first terminal of the switch 1502, and so on, until the second terminal of the resistor R150n is coupled to the first terminal of the resistor R150n+1 and the second terminal of the switch 150n, and the second terminal of the resistor R150n+1 is grounded. The first terminal of the switch 1501 is coupled to the inverse input terminal of the amplifier A1501. The sources of the PMOS transistors P1501 and P1502 are both coupled to a supply voltage VDD, and the gates of the PMOS transistors P1501 and P1502 are both coupled to the output terminal of the amplifier A1501. The first terminal of the resistor Rb is coupled to the non-inverse input terminal of the amplifier A1501 and the drain of the PMOS transistor P1501, and the second terminal of the resistor Rb is grounded.

As described above, the working principle of the variable current adjust circuit VI1500 will be described herein. The resistors R1500˜R150n+1 and the switches 1501˜150n divide the analog signal Vs, and after receiving the analog signal Vs, a proportional voltage V15 is outputted by controlling the on/off states of the switches 1501˜150n. The proportional voltage V15 is obtained according to the voltage drop of the analog signal Vs, thus, the voltage level at the inverse input terminal of the amplifier A1501 is the proportional voltage V15, and the voltage level of the non-inverse input terminal of the amplifier A1501 is equal to the proportional voltage V15 due to virtual short circuit characteristic thereof. The drain current Ir15 of the PMOS transistor P1501 is equivalent to the proportional voltage V15 divided by the resistor Rb, i.e. Ir15=V15/Rb. Assuming the PMOS transistors P1501 and P1502 have the same channel width and channel length, then the variable current I15 output by the variable current adjust circuit VI1500 and the drain current Ir15 are in ratio 1:1. Thus, the quantity of the variable current I15 output by the variable current adjust circuit VI1500 can be adjusted by controlling the on/off of the switches 1501˜150n.

Even though embodiments illustrated in FIGS. 12˜15 have been described as various implementations of the variable current adjust circuit in the present invention, the present invention is not limited thereto.

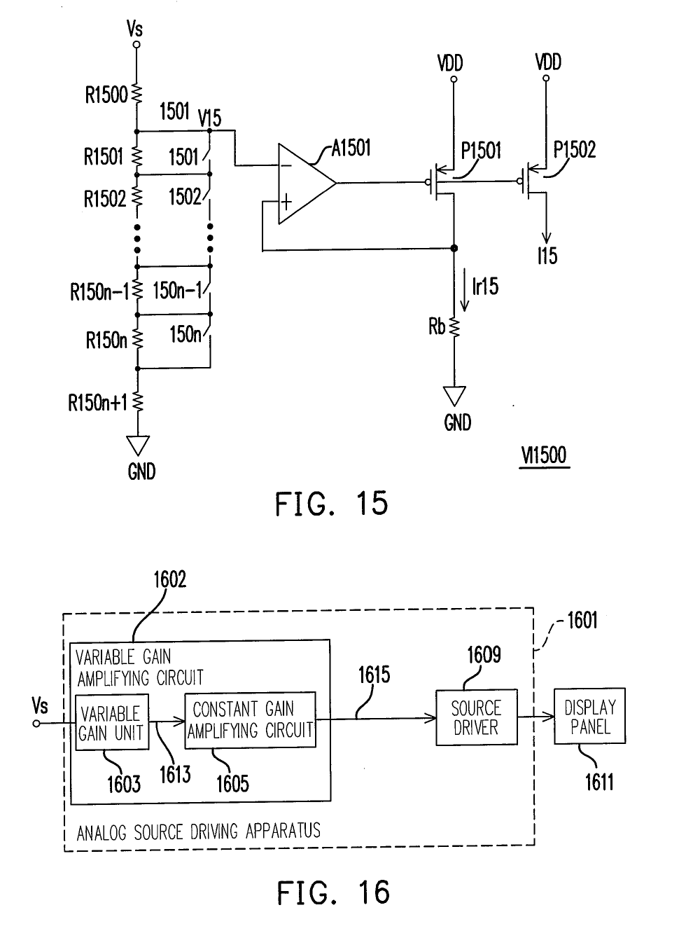

FIG. 16 is a block circuit diagram of an analog source driving apparatus according to another embodiment of the present invention. Referring to FIG. 16, the analog source driving apparatus 1601 includes a variable gain amplifying circuit 1602 and a source driver 1609, wherein the variable gain amplifying circuit 1602 includes a variable gain unit 1603 and a constant gain amplifying circuit 1605, and the variable gain unit 1603 is composed of passive elements. The couplings between various components of the analog source driving apparatus 1601 are described herein. The variable gain unit 1603 receives an analog signal Vs. The constant gain amplifying circuit 1605 is coupled to the output of the variable gain unit 1603. The source driver 1609 is coupled to the output of the constant gain amplifying circuit 1605.

As described above, the working principle of the analog source driving apparatus 1601 is described as follows. The variable gain unit 1603 receives and adjusts an analog signal Vs to generate a first voltage 1613. The constant gain amplifying circuit 1605 receives and amplifies the first voltage 1613 to output a second voltage 1615. The source driver 1609 receives the second voltage 1615 to drive a display panel 1611. Since the variable gain unit 1603 is composed of passive elements, the feedback stability of the constant gain amplifying circuit 1605 will not be changed when the output of the variable gain unit 1603 is adjusted. Besides, the feedback control of the constant gain amplifying circuit 1605 does not have the problem of position shift of the zero point or pole point, therefore the positions of the pole point and zero point are not changed before and after adjusting the gain of the variable gain unit 1603, and accordingly the original zero point position and pole point position of the stable analog source driving apparatus 1601 are not affected. Accordingly, the stability of the analog source driving apparatus 1601 is maintained when adjusting the gain with the variable gain unit 1603.

Here, the analog source driving apparatuses in FIGS. 2 and 16 will be compared. Referring to FIGS. 2 and 16, the main difference between the two is that the variable gain unit 1603 is composed of passive elements. Thus, the implementation of the variable gain unit 1603 can be referred to foregoing descriptions described with reference to FIGS. 3˜5, and FIGS. 3˜5 illustrate various variable gain units. Next, the variable gain unit may use variable resistors, such as variable resistors 301, 303, 401, or 503 etc, and can be implemented as described with reference to FIGS. 9˜11.

In summary, in an analog source driving apparatus provided by the present invention, a variable gain unit is adopted for modulating an analog signal, and the procedure of the variable gain unit adjusting the analog signal is a open-loop process, therefore the variable gain unit will not affect the zero point position and pole point position of the feedback circuit of subsequently coupled elements, wherein the feedback circuit may be an amplifying circuit formed by the operational amplifier and resistors or a constant gain amplifying circuit. Since the equivalent input resistance and equivalent output resistance of the feedback circuit are not changed, the zero point position and pole point position of the original stable system are not shifted. Accordingly, the zero point position and pole point position of the original stable feedback circuit may be maintained when the variable gain unit is used for adjusting gain and amplifying analog signal. According to embodiments of the present invention, the analog source driving apparatus has broad gain adjustment range when the received analog signal is amplified or reduced, and the analog source driving apparatus can maintain the original system stability when it amplifies analog signals and provide stable driving output.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An analog source driving apparatus, comprising:
an operational amplifier, comprising an output terminal, an inverse input terminal, and a non-inverse input terminal, for receiving a first voltage and outputting a second voltage;
a first resistor, comprising a first terminal and a second terminal, wherein the first terminal of the first resistor is coupled to the inverse input terminal of the operational amplifier, and the second terminal of the first resistor is grounded;
a second resistor, comprising a first terminal and a second terminal, wherein the first terminal of the second resistor is coupled to the inverse input terminal of the operational amplifier and the first terminal of the first resistor, and the second terminal of the second resistor is coupled to the output terminal of the operational amplifier;
a variable gain unit, coupled to the non-inverse input terminal of the operational amplifier, for receiving and modulating an analogy signal and generating the first voltage according to the analog signal; and
a source driver, coupled to the output terminal of the operational amplifier, for receiving the second voltage for driving a display panel.

2. The analog source driving apparatus according to claim 1, wherein the variable gain unit comprises:
a first variable resistor, for receiving the analog signal; and
a second variable resistor, coupled between the first variable resistor and the ground,
wherein the first voltage is obtained at a coupling point of the first variable resistor and the second variable resistor.

3. The analog source driving apparatus according to claim 1, wherein the variable gain unit comprises:
a third variable resistor, for receiving the analog signal; and
a third resistor, coupled between the third variable resistor and the ground,
wherein the first voltage is obtained at a coupling point of the third variable resistor and the third resistor.

4. The analog source driving apparatus according to claim 1, wherein the variable gain unit comprises:
a fourth resistor, for receiving the analog signal; and
a fourth variable resistor, coupled between the fourth resistor and the ground,
wherein the first voltage is obtained at a coupling point of the fourth resistor and the fourth variable resistor.

5. The analog source driving apparatus according to claim 1, wherein the variable gain unit comprises:
a current adjust circuit, comprising a first terminal and a second terminal, the first terminal of the current adjust circuit being coupled to the analog signal; and
a fifth variable resistor, coupled between the second terminal of the current adjust circuit and the ground,
wherein the current adjust circuit outputs an adjusted current according to the analog signal, and the first voltage is obtained at a coupling point of the current adjust circuit and the fifth variable resistor.

6. The analog source driving apparatus according to claim 1, wherein the variable gain unit comprises:
a first variable current adjust circuit, comprising a first terminal and a second terminal, the first terminal of the first variable current adjust circuit being coupled to the analog signal; and
a fifth resistor, coupled between the second terminal of the first variable current adjust circuit and the ground,
wherein the first variable current adjust circuit outputs a first variable current according to the analog signal and also adjusts the first variable current, and the first voltage is obtained at a coupling point of the first variable current adjust circuit and the fifth resistor.

7. The analog source driving apparatus according to claim 1, wherein the variable gain unit comprises:
a second variable current adjust circuit, comprising a first terminal and a second terminal, the first terminal of the second variable current adjust circuit being coupled to the analog signal; and
a sixth variable resistor, coupled between the second terminal of the second variable current adjust circuit and the ground,
wherein the second variable current adjust circuit outputs a second variable current according to the analog signal and adjusts the second variable current, and the first voltage is obtained at a coupling point of the second variable current adjust circuit and the sixth variable resistor.

8. An analog source driving apparatus, comprising:
a variable gain amplifying circuit, comprising:
a variable gain unit, for receiving and modulating an analog signal and generating a first voltage, wherein the variable gain unit is composed of passive elements; and
a constant gain amplifying circuit, coupled to the variable gain unit, receiving the first voltage, for amplifying the first voltage and outputting a second voltage; and
a source driver, coupled to the output of the constant gain amplifying circuit, for receiving the second voltage for driving a display panel.

9. The analog source driving apparatus according to claim 8, wherein the variable gain unit comprises:
a first variable resistor, for receiving the analog signal; and
a second variable resistor, coupled between the first variable resistor and the ground,
wherein the first voltage is obtained at a coupling point of the first variable resistor and the second variable resistor.

10. The analog source driving apparatus according to claim 8, wherein the variable gain unit comprises:
a third variable resistor, for receiving the analog signal; and
a first resistor, coupled between the third variable resistor and the ground,
wherein the first voltage is obtained at a coupling point of the third variable resistor and the first resistor.

11. The analog source driving apparatus according to claim 8, wherein the variable gain unit comprises:
a second resistor, for receiving the analog signal; and
a fourth variable resistor, coupled between the second resistor and the ground,
wherein the first voltage is obtained at the coupling point of the second resistor and the fourth variable resistor.
